(19) United States
(12) Patent Application Publication
(10) Pub. No.: US 2025/0125448 A1
(43) Pub. Date: Apr. 17, 2025

(54) THERMAL BARRIER AND VENTING SYSTEMS FOR TRACTION BATTERY ARRAYS

(71) Applicant: FORD GLOBAL TECHNOLOGIES, LLC, Dearborn, MI (US)

(72) Inventors: Di ZHU, Novi, MI (US); Steven F. CHORIAN, Canton, MI (US); Bhaskara Rao BODDAKAYALA, Troy, MI (US); Joseph POLIZZI, Chesterfield, MI (US); Sergei VARNAVSKI, Ann Arbor, MI (US); Jordyn COBBS, Detroit, MI (US); Timothy J. GARDNER, Wyandotte, MI (US); Giriraj SRINIVASAN, Troy, MI (US)

(21) Appl. No.: 18/484,658

(22) Filed: Oct. 11, 2023

(51) Int. Cl. H01M 10/658; F16J 15/10; H01M 50/211; H01M 50/291; H01M 50/367

(52) U.S. Cl. CPC H01M 10/658; F16J 15/102; H01M 50/211; H01M 50/291; H01M 50/367; H01M 2220/20

(57) ABSTRACT

Battery arrays are provided for traction battery packs. An exemplary battery array may include a thermal barrier and venting system for mitigating cell-to-cell and/or cell bank-to-cell bank thermal propagation. The battery thermal barrier and venting system may further include one or more vent passageways for establishing dedicated venting paths for expelling gases and other effluents from the battery array during battery thermal events.

### TECHNICAL FIELD

This disclosure relates generally to traction battery packs, and more particularly to thermal barrier and venting systems for managing battery cell vent byproducts and mitigating thermal propagation during battery thermal events.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, a first cell bank including a first plurality of battery cells, a second cell bank including a second plurality of battery cells, and a partition assembly arranged to separate the first cell bank from the second cell bank. The partition assembly includes a thermal barrier plate and a seal.

In a further non-limiting embodiment of the foregoing battery array, the first cell bank and the second cell bank are housed inside an outer array housing.

In a further non-limiting embodiment of either of the foregoing battery arrays, a thermal insulation blanket is arranged between a top plate of the outer array housing and at least one of the first cell bank or the second cell bank.

In a further non-limiting embodiment of any of the foregoing battery arrays, the seal is configured to seal against an inner surface of the thermal insulation blanket to isolate the first cell bank from the second cell bank.

In a further non-limiting embodiment of any of the foregoing battery arrays, the thermal insulation blanket is made of a flame resistant and heat insulation material.

In a further non-limiting embodiment of any of the foregoing battery arrays, a foam sheet is arranged between the thermal insulation blanket and at least one of the first cell bank or the second cell bank.

In a further non-limiting embodiment of any of the foregoing battery arrays, the foam sheet is a polyurethane foam sheet.

In a further non-limiting embodiment of any of the foregoing battery arrays, the thermal barrier plate includes mica.

In a further non-limiting embodiment of any of the foregoing battery arrays, the seal is a compressible seal made of a silicone-based material.

In a further non-limiting embodiment of any of the foregoing battery arrays, the partition assembly divides an interior of the battery array into a first portion where the first cell bank resides and a second portion where the second cell bank resides.

In a further non-limiting embodiment of any of the foregoing battery arrays, a first vent passageway is fluidly connected to the first cell bank, and a second vent passageway is fluidly connected to the second cell bank.

In a further non-limiting embodiment of any of the foregoing battery arrays, a first vent passageway cover is arranged to cover the first vent passageway, and a second vent passageway cover is arranged to cover the second vent passageway.

In a further non-limiting embodiment of any of the foregoing battery arrays, each of the first vent passageway cover and the second vent passageway cover includes a mica strip.

In a further non-limiting embodiment of any of the foregoing battery arrays, the seal straddles an upper portion of the thermal barrier plate.

In a further non-limiting embodiment of any of the foregoing battery arrays, the seal includes an end flange section having a stepped profile.

A battery array for a traction battery pack according to another exemplary aspect of the present disclosure includes, among other things, an outer array housing, a first cell bank and a second cell bank housed inside the outer array housing, a thermal insulation blanket arranged between a plate of the outer array housing and at least one of the first cell bank or the second cell bank, and a partition assembly including a thermal barrier plate positioned axially between the first cell bank and the second cell bank and a seal arranged to seal an interface between the partition assembly and the thermal insulation blanket.

In a further non-limiting embodiment of the foregoing battery array, the plate is a top plate of the outer array housing.

In a further non-limiting embodiment of either of the foregoing battery arrays, the thermal insulation blanket supports a flexible wire of the battery array.

In a further non-limiting embodiment of any of the foregoing battery arrays, a foam sheet is arranged between the thermal insulation blanket and at least one of the first cell bank or the second cell bank.

In a further non-limiting embodiment of any of the foregoing battery arrays, a first vent passageway is fluidly connected to the first cell bank, and a second vent passageway is fluidly connected to the second cell bank.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a battery array of a traction battery pack.

FIG. 3 is a cross-sectional view through section 3-3 of FIG. 2.

FIG. 4 illustrates an exemplary seal of a thermal barrier and venting system.

FIG. 5 illustrates an interface between the seal of FIG. 4 and a thermal barrier plate of the thermal barrier and venting system.

FIG. 6 illustrates an end flange section of the seal of FIG. 4.

FIG. 7 illustrates an interface between the end flange section of FIG. 6 and a portion of an outer array housing of a battery array.

### DETAILED DESCRIPTION

This disclosure details battery arrays for traction battery packs. An exemplary battery array may include a thermal barrier and venting system for mitigating cell-to-cell and/or cell bank-to-cell bank thermal propagation. The battery thermal barrier and venting system may further include one or more vent passageways for establishing dedicated venting paths for expelling gases and other effluents from the battery array during battery thermal events. These and other features are discussed in greater detail in the following paragraphs of this detailed description.

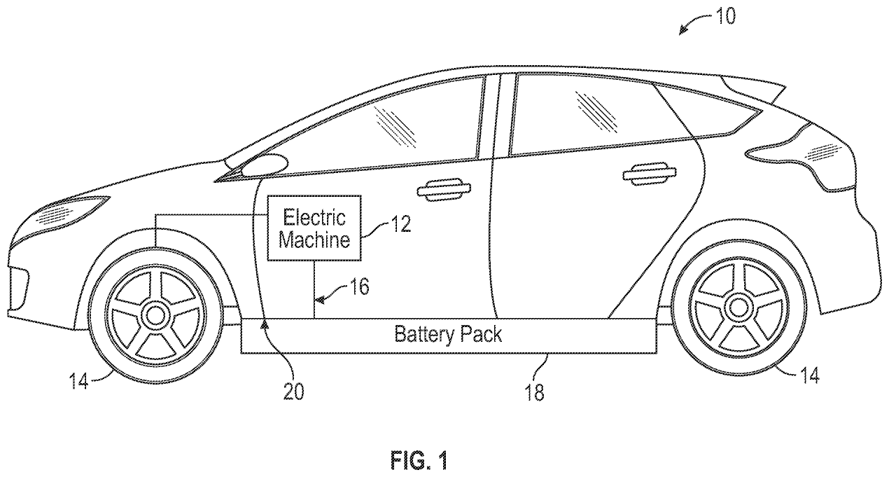

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

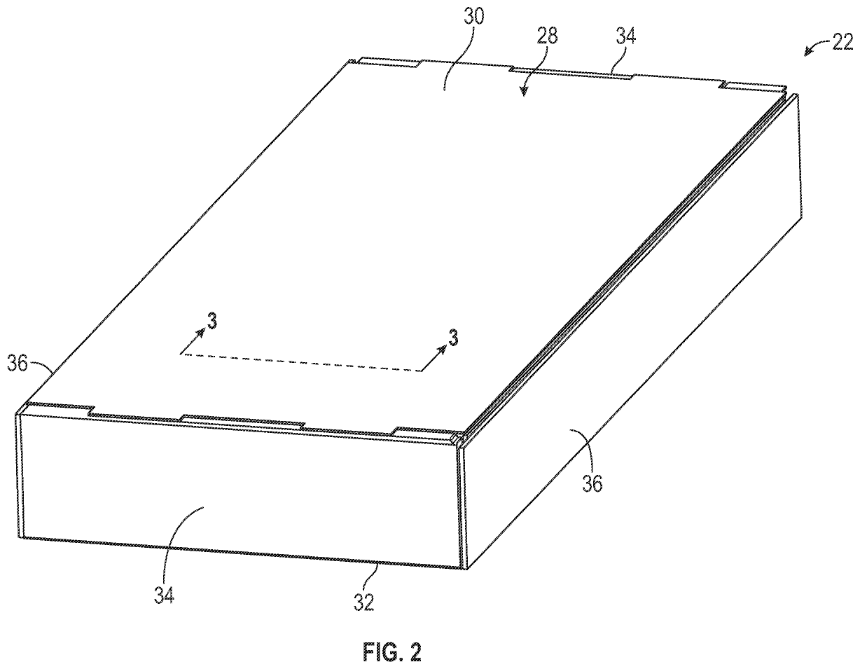

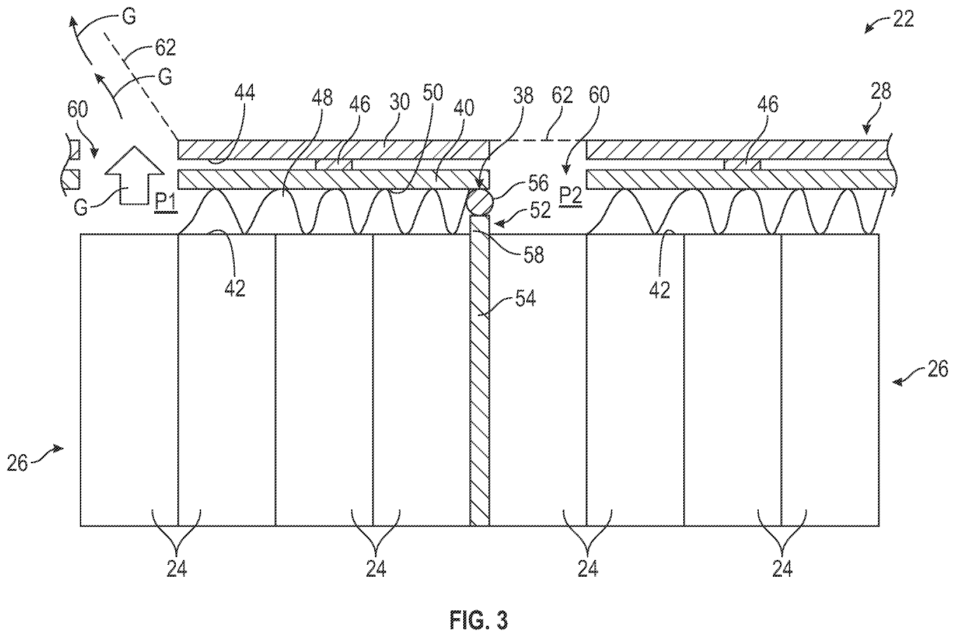

FIGS. 2 and 3 illustrate an exemplary battery array 22 for a traction battery pack, such as the traction battery pack 18 of FIG. 1, for example. One or more battery arrays having a design similar to the battery array 22 shown in FIGS. 2-3 could be packaged within the traction battery pack 18.

The battery array 22 may include a plurality of battery cells 24 (see FIG. 3). In an embodiment, the battery cells 24 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The total number of battery cells 24 provided within the battery array 22 may vary and is not intended to limit this disclosure.

The battery cells 24 may be stacked side-by-side along a stack axis to construct a grouping of battery cells 24, sometimes referred to as a “cell stack.” The cell stack of the battery array 22 may be grouped into two or more cell banks 26. In the illustrated embodiment, each cell bank 26 includes a total of four battery cells 24. However, the cell banks 26, and thus the battery array 22, could include any number of battery cells 24 within the scope of this disclosure.

An outer array housing 28 of the battery array 22 may be arranged to substantially surround the cell banks 26. In an embodiment, the array outer housing 28 completely encloses the battery cells 24 of each cell bank 26 and includes a top plate 30, a bottom plate 32, a pair of end plates 34, and a pair of side plates 36. One or more of the top plate 30, the bottom plate 32, the end plates 34, and the side plates 36 may be integrated together as part of a unitary structure. For example, the bottom plate 32 and the end plates 34 could be integrated together to form a unitary array structure that interfaces with the top plate 30. However, other configurations of the outer array housing 28 are also possible within the scope of this disclosure.

Although rare, the battery array 22 could experience a battery thermal event during its operation. A battery thermal event may occur, for example, during over-charging conditions, over-discharging conditions, or other conditions and can cause one or more of the battery cells 24 to expel battery vent byproducts that can include gases, effluent particles, and/or other vent byproducts. The battery array 22 may therefore include a thermal barrier and venting system 38 (hereinafter referred to simply as “the system 38”) for mitigating the effects of battery thermal events. For example, among other benefits, the system 38 may be configured to prolong the amount of time it takes for electrical energy to transfer from cell-to-cell and/or from cell bank-to-cell bank across the battery array 22 during battery thermal events. The system 38 may be further configured to vent gases G and/or other effluents released by one or more of the battery cells 24 along a desired vent path to a location outside of the battery array 22 (e.g., external to the outer array housing 28) during battery thermal events.

Referring now primarily to FIG. 3, the system 38 may include one or more thermal barrier blankets 40 positioned in the space extending between top surfaces 42 of the battery cells 24 and an inner surface 44 of the top plate 30 of the outer array housing 28. The thermal barrier blanket 40 may support one or more flexible wires 46 (e.g., of a flexible printed circuit, shown schematically) of the battery array 22. Notably, the various components of the system 38 are not necessarily drawn to scale, and in the interests of simplicity and clarity, are shown in a highly schematic manner in FIG. 3.

Each thermal barrier blanket 40 may be made of a flame resistant and heat insulation material. The flame resistant and heat insulation material may include one or more of mica, aerogel materials, refractory ceramic fibers, fiberglass, etc. However, other materials or combinations of materials could be utilized to provide the flame resistant and heat insulation properties of the thermal barrier blanket 40 within the scope of this disclosure.

The system 38 may further include one or more foam sheets 48 positioned in the space between the top surfaces 42 of the battery cells 24 and an inner surface 50 of the thermal barrier blanket 40. Each foam sheet 48 may be made of a polyurethane foam. However, other materials or combinations of materials could be utilized to construct the foam sheet 48 within the scope of this disclosure. The thermal barrier blanket 40 and the foam sheet 48 may cooperate to protect the top plate 30 of the outer array housing 28 during battery thermal events, such as from relatively hot concentrated jets of gas, for example.

The foam sheets 48 may serve multiple functions. The foam sheets 48 generally are capable of thermally resisting both high and low temperatures. Moreover, since they are insulative, heat is encouraged to reject towards desired locations and away from undesirable locations. The dielectric nature of the foam materials can prevent arcing between battery cells during a battery thermal event. The foam sheets 48 can also prevent the introduction of contaminants, such as moisture and debris, within the battery array 22.

The system 38 may further include one or more partition assemblies 52. In an embodiment, the partition assembly 52 is positioned axially between a pair of neighboring cell banks 26 of the cell stack of the battery array 22. The partition assembly 52 may additionally interface with the thermal barrier blanket 40. As further discussed below, the partition assembly 52 may isolate a first portion P1 of an interior of the battery array 22 where a first of the cell banks 26 resides from a second portion P2 of the interior where a neighboring cell bank 26 resides.

The partition assembly 52 may include a thermal barrier plate 54 and a seal 56. The thermal barrier plate 54 may be positioned axially between the neighboring pair of cell banks 26 of the battery array 22. The thermal barrier plate 54 may be a single layer or multi-layer structure designed to mitigate cell bank-to-cell bank thermal propagation during a battery thermal event. In an embodiment, the thermal barrier plate 54 is made of mica. However, other flame resistant and heat insulation materials or combinations of materials could be utilized as part of the thermal barrier plate 54 within the scope of this disclosure.

The seal 56 of the partition assembly 52 may be configured to seal an interface between the thermal barrier plate 54 and the thermal barrier blanket 40. Thus, the thermal barrier plate 54 and the seal 56 may cooperate to divide the interior of the battery array 22 into the first portion P1 and the second portion P2. The seal 56 may be arranged to extend between the inner surface 50 of the thermal barrier blanket 40 and an upper portion 58 of the thermal barrier plate 54. The upper portion 58 may extend above the top surfaces 42 of the battery cells 24.

In an embodiment, the seal 56 is made of a compressible material, such as a silicone-based material, for example. However, other compressible materials or combinations of materials are contemplated within the scope of this disclosure.

The system 38 may further include a plurality of vent passageway 60 for expelling gases G or other effluents from the battery array 22 along an established and predicable gas path during battery thermal events. The vent passageways 60 may be established by slots or openings formed through each of the top plate 30, the thermal barrier blanket 40, and the foam sheet 48.

Each cell bank 26 of the battery array 22 may include one or more dedicated vent passageways 60. For example, a first portion of the vent passageways 60 may be in fluid communication with the first portion P1 of the interior of the battery array 22, and a second portion of the vent passageways 60 may be in fluid communication with the second portion P2 of the interior of the battery array 22. Therefore, the gases G may be expelled from the battery array 22 irrespective of which cell bank 26 is experiencing the battery thermal runaway event and without substantially transferring heat to the neighboring cell bank(s) 26.

Each vent passageway 60 may be covered by a vent passageway cover 62. One end of each vent passageway cover 62 may be secured to the top plate 30, such as by section of double sided adhesive tape, for example. The vent passageway covers 62 may be configured to open to allow the gases G to pass through the vent passageways 60 during battery venting events. The vent passageway covers 62 may be made of a mica strip, ceramic paper, glass mat thermoplastic composites, etc.

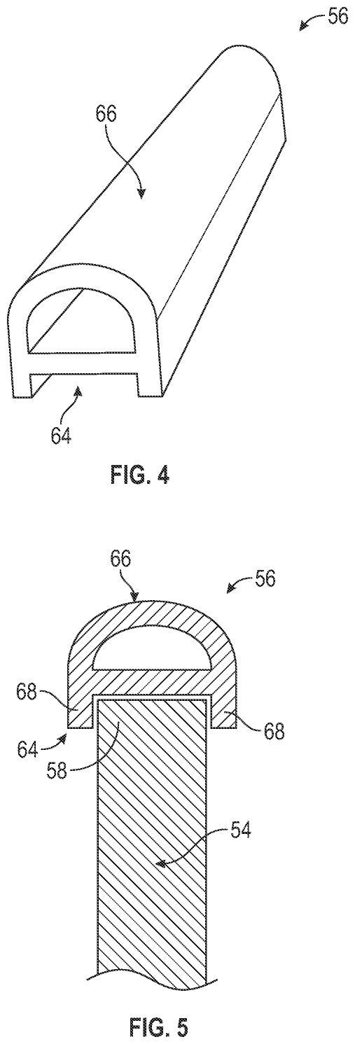

FIGS. 4 and 5 illustrate an exemplary design of the seal 56 of the partition assembly 52 of the system 38 described above. The seal 56 may include a base portion 64 and a bulbous portion 66 that extends from the base portion 64. The base portion 64 may be configured to interface with the thermal barrier plate 54 of the partition assembly 52, and the bulbous portion 66 may be configured to interface with the inner surface 50 of the thermal barrier blanket 40.

The base portion 64 of the seal 56 may be arranged to straddle the upper portion 58 of the thermal barrier plate 54 (see, e.g., FIG. 5). For example, projecting legs 68 of the base portion 64 may flank the upper portion 58 of the thermal barrier plate 54 when the seal 56 is received over the thermal barrier plate 54.

The bulbous portion 66 of the seal 56 may be hollow and may include a half-cylinder shape. However, other configurations are contemplated within the scope of this disclosure.

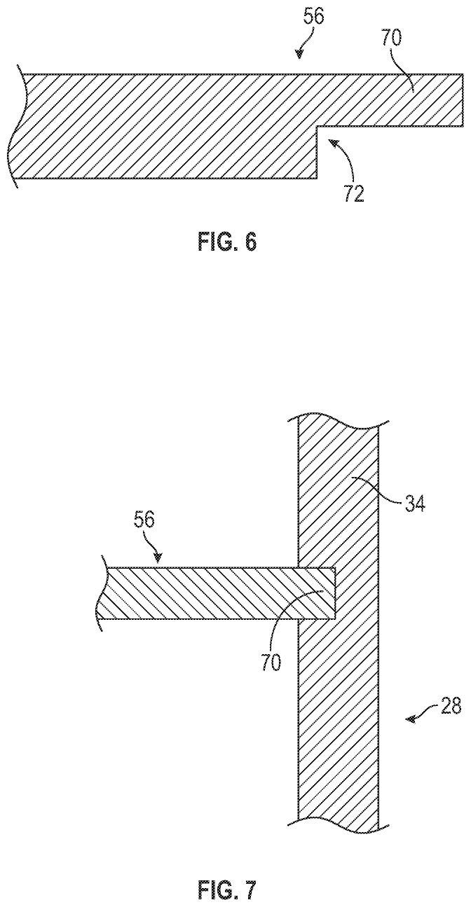

Referring now to FIGS. 6 and 7, the seal 56 may include one or more end flange sections 70. Each end flange section 70 may be designed to interface with a portion of the outer array housing 28. The end flange section 70 may include a stepped profile 72 for interfacing with one of the end plates 34 of the outer array housing 28, for example (see FIG. 7). The seal 56 may therefore be adequately supported along its length for establishing the sealed interface relative to the thermal barrier blanket 40.

The exemplary battery arrays of this disclosure include battery thermal barrier and venting systems for mitigating or event preventing thermal propagation inside electrified vehicle traction battery arrays. The proposed systems may provide numerous advantages over known solutions, including but not limited to presenting a novel configuration that significantly slows or even prevents cell-to-cell and cell bank-to-cell bank thermal propagation while providing dedicated venting passageways for expelling battery vent byproducts during battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
a first cell bank including a first plurality of battery cells;
a second cell bank including a second plurality of battery cells; and
a partition assembly arranged to separate the first cell bank from the second cell bank,
wherein the partition assembly includes a thermal barrier plate and a seal.

2. The battery array as recited in claim 1, wherein the first cell bank and the second cell bank are housed inside an outer array housing.

3. The battery array as recited in claim 2, comprising a thermal insulation blanket arranged between a top plate of the outer array housing and at least one of the first cell bank or the second cell bank.

4. The battery array as recited in claim 3, wherein the seal is configured to seal against an inner surface of the thermal insulation blanket to isolate the first cell bank from the second cell bank.

5. The battery array as recited in claim 3, wherein the thermal insulation blanket is made of a flame resistant and heat insulation material.

6. The battery array as recited in claim 3, comprising a foam sheet arranged between the thermal insulation blanket and at least one of the first cell bank or the second cell bank.

7. The battery array as recited in claim 6, wherein the foam sheet is a polyurethane foam sheet.

8. The battery array as recited in claim 1, wherein the thermal barrier plate includes mica.

9. The battery array as recited in claim 1, wherein the seal is a compressible seal comprised of a silicone-based material.

10. The battery array as recited in claim 1, wherein the partition assembly divides an interior of the battery array into a first portion where the first cell bank resides and a second portion where the second cell bank resides.

11. The battery array as recited in claim 1, comprising a first vent passageway fluidly connected to the first cell bank and a second vent passageway fluidly connected to the second cell bank.

12. The battery array as recited in claim 11, comprising a first vent passageway cover arranged to cover the first vent passageway, and a second vent passageway cover arranged to cover the second vent passageway.

13. The battery array as recited in claim 12, wherein each of the first vent passageway cover and the second vent passageway cover includes a mica strip.

14. The battery array as recited in claim 1, wherein the seal straddles an upper portion of the thermal barrier plate.

15. The battery array as recited in claim 1, wherein the seal includes an end flange section having a stepped profile.

16. A battery array for a traction battery pack, comprising:
an outer array housing;
a first cell bank and a second cell bank housed inside the outer array housing;
a thermal insulation blanket arranged between a plate of the outer array housing and at least one of the first cell bank or the second cell bank; and
a partition assembly including a thermal barrier plate positioned axially between the first cell bank and the second cell bank and a seal arranged to seal an interface between the partition assembly and the thermal insulation blanket.

17. The battery array as recited in claim 16, wherein the plate is a top plate of the outer array housing.

18. The battery array as recited in claim 16, wherein the thermal insulation blanket supports a flexible wire of the battery array.

19. The battery array as recited in claim 16, comprising a foam sheet arranged between the thermal insulation blanket and at least one of the first cell bank or the second cell bank.

20. The battery array as recited in claim 16, comprising a first vent passageway fluidly connected to the first cell bank and a second vent passageway fluidly connected to the second cell bank.
